(19) United States
(12) Patent Application Publication
(10) Pub. No.: US 2009/0123903 A1
(43) Pub. Date: May 14, 2009

(54) Methods and systems for tracking progress and conducting private mentoring on tutorial web documents

(76) Inventor: Chrstian Weitenberner, Playa Del Rey, CA (US)

Correspondence Address: Christian Weitenberner, Unit 4316, 8505 Gulana Ave, Playa Del Rey, CA, 90293, US

(21) Appl. No.: 12/284,512

(22) Filed: Sep. 23, 2008

Related U.S. Application Data
(60) Provisional application No. 60/975,117, filed on Sep. 25, 2007.

(51) Int. Cl. G09B 7/00

(52) U.S. Cl. 434/323

(57) ABSTRACT

Tutorial web documents may include the ability to track the progress of learning by step or by section. The learning progress may be recorded and displayed to a specific user, groups of users, or to the public. Tutorial web documents may allow users to establish private mentoring sessions between one or more users. Private mentoring session information may be recorded by the system. Session information may be shared between users and/or networks. User may initiate and or join multiple private mentoring sessions.

This application claims priority to provisional application No. 60975117 dated Sep. 25, 2007

### FIELD OF INVENTION

The invention generally relates to the field of entertainment and educational based tutorial web documents, and more specifically but not limited to tracking progress on such web documents as well as facilitating private mentoring on such web documents.

### BACKGROUND

People are increasingly using the Internet to learn new skills and accomplish personal goals. New techniques for learning on the Internet have evolved that enable Internet end users to learn from the advice of others and to contribute their expertise as well. Companies are continuously developing technologies to improve the techniques of Internet based learning.

### SUMMARY OF THE INVENTION

For some embodiments, methods and systems to enable the tracking of progress through the process of learning on tutorial web documents and to enable private mentoring on tutorial web documents may be disclosed. Tutorial web pages may display how-to information typically broken out into sections or steps. Each section or step may refer to a particular task or subtask to be accomplished. The end user may track the progress of learning by section, step, or total completion. The end user of such tutorials may want to track the progress of learning. The ability to track progress may make the process of learning more efficient by allowing the end user to return to tutorials and continue where they last left off. The end users may be learning several tutorials within a period of time. The end users may keep track of which tutorials they are learning and how far along they are in each tutorial. The tracking data may also be used to communicate one end user's learning interests to other end users, publicly or privately.

For some embodiments, the end users may want to obtain mentoring or participate as a mentor on various tutorials. An end user seeking mentorship (also referred to as a mentee) may post a request for mentoring on the tutorial page or elsewhere on the tutorial web site. A prospective mentor end user may see this request and apply as a mentor. The mentee may agree to engage in a mentoring session with an applicant mentor. The mentor and mentee may proceed in a private online mentoring session and exchange information. The information may include ideas, advice, electronic media, etc. Additional prospective mentor(s) may have the option of joining an established mentoring session.

For some embodiments, the mentee may close the mentoring session to additional mentors. The mentee may also decide to mentor others in return. Theses methods should improve the overall quality of the learning experience for tutorial web documents.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A illustrates an example of a computer system, in accordance with some embodiments.

FIG. 1B illustrates an example of a process that may be used to track progress on a tutorial web document, in accordance with some embodiments.

FIG. 2 illustrates an example of a process where an end user requests mentoring for a particular tutorial document, in accordance with some embodiments.

FIG. 3 illustrates an example of a process where a mentor discovers an end user who is requesting mentorship, in accordance with some embodiments.

FIG. 4 illustrates an example of a process where a mentor applies for mentorship and the application is reviewed by the end user for acceptance, in accordance with some embodiments.

FIG. 5 illustrates an example of a process where the mentor application is completed and the end user and mentor interact in a mentoring session, in accordance with some embodiments.

FIGS. 6-12 illustrates various example web pages that may be used to enable an end user to accomplish one or more operations associated with the tutorial web document processes, in accordance with some embodiments.

### DETAILED DESCRIPTION

For some embodiments, methods and systems that may be used to track the progress of learning on tutorial web documents and/or enable private mentoring on tutorial web documents are disclosed. A tutorial web document may be enabled to support progress tracking. The tutorial web document may also be enabled to support mentoring.

In the following detailed description, numerous specific details are set forth. However, it is understood that embodiments of the invention may be practiced without these specific details. In other instances, well-known circuits, structures, and techniques have not been shown in detail in order to not obscure the understanding of this description. These embodiments are described in sufficient detail to enable those of ordinary skill in the art to practice the invention. The following detailed description is, therefore, not to be taken in a limiting sense, and the scope of the invention is defined only by the appended claims.

### Introduction

A tutorial web document may be defined as a web document that provides the end user with text and media information that may be used to facilitate the learning of one or more particular subjects or some facets of a particular subject. Tutorial information may be displayed as one continuous prose or it may be broken into sections or steps. An end user may request for help from a mentor. The end user who enters into a mentoring session with a mentor may also be referred to as a mentee. An end user may become a mentor after gaining knowledge learning from the tutorial web document.

### Computer System

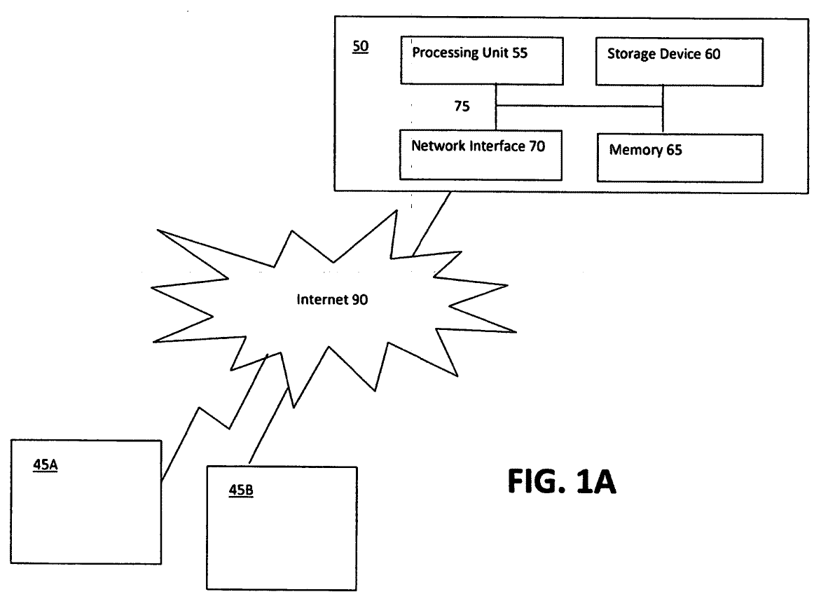

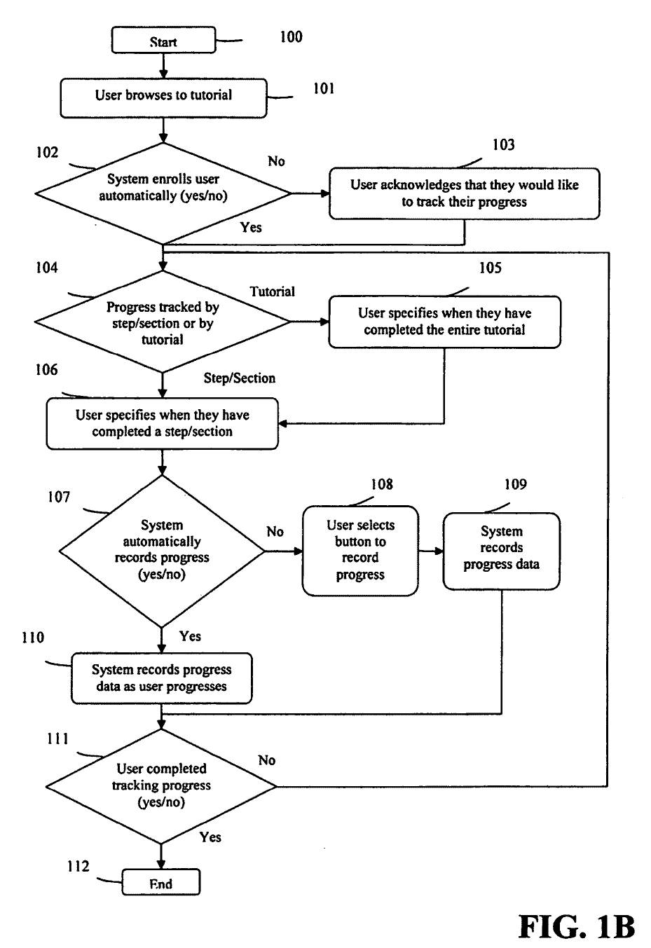

FIG. 1A illustrates an example of a computer system that may be used, in accordance with some embodiments. Computer system 50 may include one or more processing units 55 coupled via bus 75 to storage devices 60, memory 65, network interface 70 and other logic. The network interface 70 may be used to enable communication over the Internet 90

The storage devices 60 may be configured to store multiple tutorial web documents, user accounts, progress tracking information, mentoring information, and so on. The storage devices 60 may also be configured to store software associated with functionalities necessary to enable the end users to create tutorial web documents, to access the tutorial web documents, to enable progress tracking, to request and apply for mentorship, and so on. The software may also be stored in computer readable media that may include, for example, fixed media and removable media.

Access to the information stored in the storage devices 60 may be performed via a web site using the Internet. A user may access the web site using an Internet browser software included in client computer system 45A connected to the Internet 90. There may be multiple client computer systems. For example, another end user may access the web site using client computer system 45B. Although not shown, each of the computer systems 45A and 45B may also include its own processing unit, memory, storage device, network interface, and other logic. It may be noted that the computer system 50 may be a single computer system or multiple networked computer systems. Similarly, the storage devices 60 may include multiple storage devices associated with a network and with computer systems located in one or more geographical areas.

In order for the computer system 50 to track the individual end user's progress, the end user may be required to create a user account on a web site associated with the computer system 50. Alternatively, the computer system 50 may be able to uniquely identify this user by other means such as cookies, Internet protocol (IP) addresses, machine name, etc. The web site may include multiple web pages, each providing one or more user interfaces to enable the end users to perform various operations associated with the tutorial web documents.

### Progress Tracking Process

The tutorial web document may allow the end user to track progress of learning. The end user may acknowledge the completed progress by, for example, clicking a check box placed adjacent to a particular section/step of the tutorial document that the end user has learned or completed. The system or web site associated with the tutorial web document may retain of all the completed acknowledgements and tracking data on a particular tutorial document and provide that information to the end user.

FIG. 1B illustrates an example process that may be used on a tutorial web document to track the progress of learning for end users, in accordance with some embodiments. The processes may be implemented in software or a combination of both hardware and software.

The process may start at block 100. An end user may browse a tutorial web document of interest, as illustrated in block 101. The tutorial web document may be made available on a web site accessible via the Internet. The web site may be implemented to include logic to support tutorial web documents as described herein.

At block 102, it is to be determined whether the system should enroll the end user automatically when the end user browses to the tutorial web document, or if the end user is required to actively acknowledge enrollment. The end user may confirm enrollment by, for example, clicking a button on a web page. Enrolling in a tutorial web document may include acknowledgement that the web site should start tracking the progress of learning for the particular end user.

At block 103, the end user may actively acknowledge that the end user wants to start tracking the progress of learning on this tutorial web document. The web site may record this confirmation along with other relevant data.

At block 104, it is to be determined whether the tutorial progress is tracked by step/section or by the entire tutorial. Tracking the learning progress by step or section may be a more accurate approach of progress recording. This may allow the end user to better understand what steps or sections the end user previously completed. As such, the end user may continue from the completed point and make the time spent learning more effective. When progress is tracked at the tutorial level, this tracking may indicate that either the tutorial information has been learned or not completely learned. This method provides less progress detail to the end user. Depending on the situations, some end users may consider this tutorial level tracking a less desirable approach.

At block 105, the end user may specify when the end user has completed the learning efforts on the tutorial web document. This may be accomplished by, for example, clicking a button or link on a web page. At block 106, the end user may specify when the end user has completed learning a particular step or section of the tutorial web document. This may be accomplished by, for example, clicking a button or link on a web page.

At block 107, it is to be determined whether the web site should record the progress tracking data automatically, or when the end user acknowledges that they would like to record this data. At block 108, the end user actively acknowledges that the end user would like to record the progress tracking data. This may be accomplished by, for example, clicking a button or link on a web page.

At block 109, the system may record the progress tracking data. At block 110, the system may record the progress tracking data as the end user progresses through the tutorial web document.

At block 111, it is to be determined whether the end user has completed tracking the progress on the tutorial web document. If the end user has not completed the process of learning on this tutorial web document, the end user may proceed back to block 104 and iterate through until the end user has sufficiently completed the learning process on this tutorial web document. The progress tracking process may end at block 112.

Providing the progress information back to the end user may allow them to more easily remember their learning progress for a particular subject. If the end user is learning multiple tutorial web documents, tracking the end user's progress may prove to be very useful as the complexity of remembering the current state of learning on each individual tutorial web document may become difficult. For some embodiments, this progress data may be displayed to other end users who might want to know what subjects the end user is interested in learning and how accomplished is that end user in learning those subjects.

### Mentoring Request Process

In some cases, the end user may reach a point in the learning objectives where the end user may not understand one or more facets of a tutorial web document. For some embodiments, the end user may be able to reach out to one or more web-community members or website staff with his/her questions regarding a tutorial web document. The questions may be addressed in the form of mentorship conducted in a mentor session.

For some embodiments, the mentoring may be conducted on a public forum, or it may be offered privately between the end user and selected community members. The mentoring may be offered anonymously as desired by the end users and/or mentors. The system upon which the tutorial web documents reside may retain this mentoring session data. For some embodiments, the mentoring session data may be used to continue the mentoring session at a later time or to be offered to other end users as mentoring information.

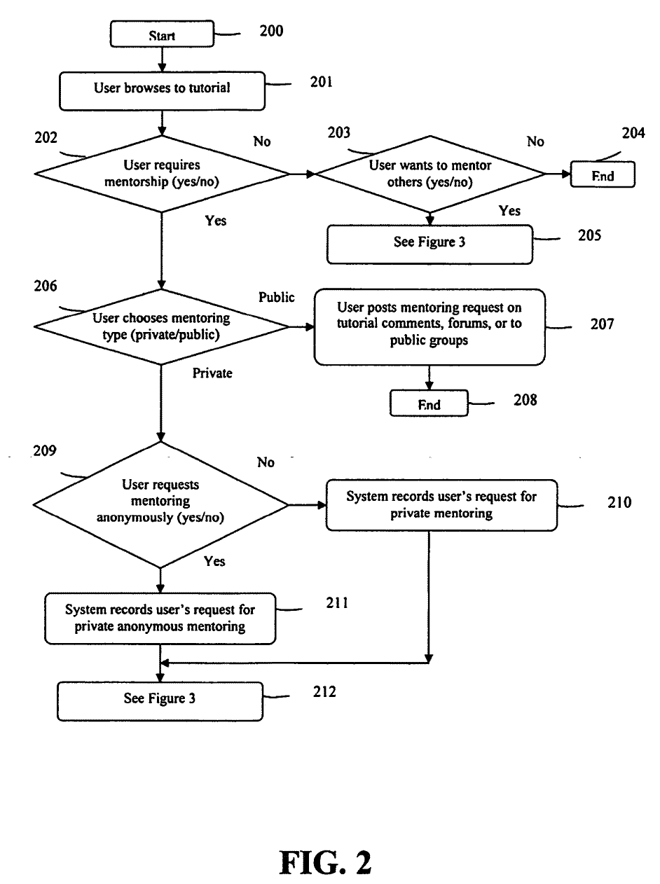

FIG. 2 illustrates an example of a process where an end user requests mentoring for a particular tutorial web document, in accordance with some embodiments. The processes may be implemented in software or a combination of both hardware and software.

The process may start at block 200. At block 201, the end user may browse a tutorial web document of interest. In order for the system to begin the mentoring process, the end user may be required to create a user account on this website. Alternatively, the system may be able to uniquely identify this end user by other means such as cookies, IP addresses, machine name, etc.

At block 202, it is to be determined whether the end user requires mentorship or not for this tutorial web document. The end user may not clearly understand the tutorial instructions, or the end user may be having difficulty with implementation or execution of the tutorial instructions and thus desires mentorship. Alternatively, the end user may choose to mentor others seeking assistance or guidance.

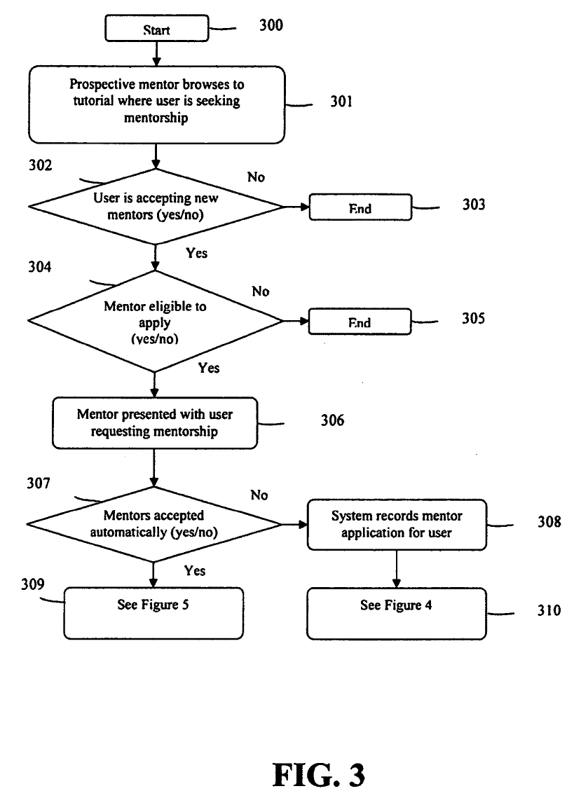

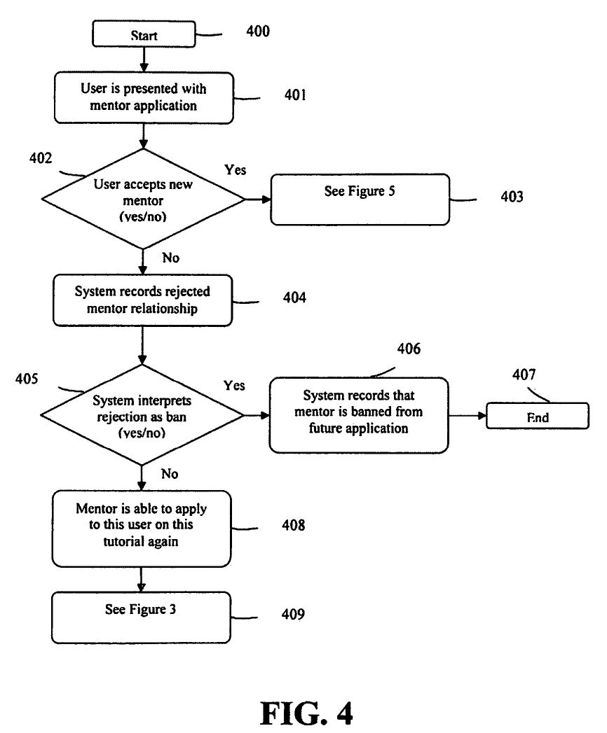

At block 203, it is to be determined whether the end user desires to mentor others or desires to not mentor others. At block 204 the process ends when the end user decides that they are not seeking mentorship and are not seeking to mentor others. The process may then continue to block 205. The operations associated with the block 205 are described in more details in FIG. 3.

At block 206, it is to be determined whether the end user chooses public or private mentoring. Public mentoring may be conducted through such outlets as internet forums, comment posting, or Internet relay chat (IRC). Private mentoring suggests an acknowledged mentoring relationship between discrete private parties. When it's public mentoring, the end user may post the questions publicly on places like internet forums, public comment lists, or IRCs. This is illustrated in block 207. The process may end when the end user decides to choose public mentoring over private mentoring, as illustrated in block 208.

When the end user chooses private mentoring, the process continues to block 209 where it is to be determined whether the end user is requesting private mentoring anonymously or not. For some embodiments, the end user may not want to publicize own identity but still obtain private mentoring. For some embodiments, there may be an option for the end user to choose either an anonymous request for private mentoring or a named request for private mentoring.

When non-anonymous private mentoring is desired, the system may record the end user's request for private named mentoring, as illustrated in block 210. When anonymous private mentoring is desired, the system records the end user's request for private anonymous mentoring, as illustrated in block 211. The process may then continue to block 212. The operations associated with the block 212 are described in more details in FIG. 3.

### Mentoring Discovery Process

FIG. 3 illustrates an example of a process where a mentor discovers an end user who is requesting mentorship, in accordance with some embodiments. The processes may be implemented in software or a combination of both hardware and software. The process may start at block 300. At block 301, a prospective mentor, who is looking to mentor other end users, may browse to the tutorial web document. There may be an indication associated with the tutorial web document that one or more end users may be seeking mentorship.

At block 302, it is to be determined whether the end user is accepting new mentors for private mentorship. This may be useful when the end user has found an adequate mentor(s) and does not want to receive additional requests from other prospective mentors for a particular tutorial web document. When the end user is not accepting any new mentors, the process for mentor discovery may end at block 303.

When the end user is accepting new mentors, the process continues to block 304. Here it is to be determined whether the prospective mentor is eligible to apply as a mentor for this particular end user and for this tutorial web document. A particular mentor may be ineligible because the mentor has previously applied as a mentor and has been denied permission. The prospective mentor may be ineligible because the mentor is not within a permissible group as specified by the end user. This may be a method of filtering out prospective mentors according to certain criteria. For some embodiments, a permissible group may be a group of end users marked as friends or colleagues for an end user, or a group of end user dedicated to a particular field of interest or expertise. When the end user is not accepting the prospective mentor as a viable candidate for mentorship, the process for mentor discovery may end at block 305.

When the end user is accepting the prospective mentor as a candidate for mentorship, the system will display the end user's request for mentorship to the prospective mentor, as illustrated in block 306. The process then continues to block 307 where it is to be determined whether the prospective mentor is automatically accepted by the system as a mentor for this end user on this tutorial web document. Automatically accepting mentors who are not on a “black-list” may be a more open approach to private mentoring. Ultimately, the end user may be presented with more mentoring candidates than with a process of mentor application. For some embodiments, the system may require all prospective mentors to apply for mentorship. This inserts a control mechanism into the process where the prospective mentors can be scrutinized before being allowed to participate as a mentor. Depending on the implementation for mentorship application, one approach may be preferred over the other.

From block 307, when the prospective mentor is not accepted automatically, the system records the prospective mentor's application to be considered as a mentor for this end user on this tutorial web document. The process may then continue to block 310 where the prospective mentor's application is reviewed by the end user (also referred to herein as mentee). The operations associated with the block 310 may be described in more details in FIG. 4.

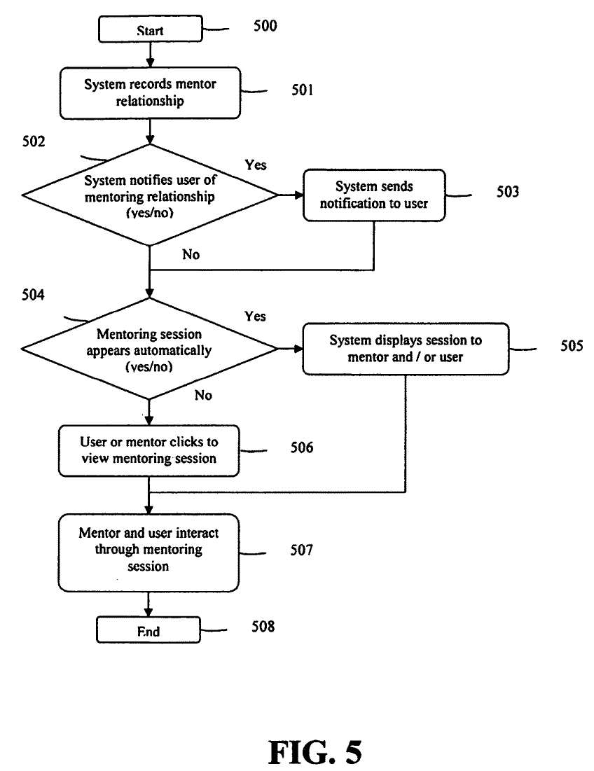

From block 307, when the prospective mentor is accepted automatically, the process may then continue to block 309 where the mentoring session between the mentor and the mentee. The operations associated with the block 309 are described in more details in FIG. 5.

### Mentoring Application Review Process

FIG. 4 illustrates an example of a process where a mentor has applied for mentorship and the application is reviewed by the mentee for acceptance, in accordance with some embodiments. The process may begin at block 400. At block 401, the mentee may be presented with the mentor application information. The mentee may review this information in order to determine if this mentor is a suitable candidate for mentorship.

At block 402, it is to be determined whether the mentee should accept the prospective mentor as a viable candidate for mentorship or not. The criteria for accepting a mentor may be subjective and may vary from one mentee to another mentee. Alternatively, the criteria for accepting a mentor may be based predetermined or recommended by the system in the form, for example, of a checklist. A mentee may go through the checklist to determine if the prospective mentor may be accepted.

When the mentee accepts the prospective mentor as a viable candidate, the process continues to FIG. 5 where the mentoring process finishes and allows the mentor and mentee to begin interaction, as illustrated in block 403.

When the end user decides to decline the prospective mentor as a viable candidate, the system records this rejected application decision, as illustrated in block 404. For some embodiments, it may be valuable to both the system, the mentee, and prospective mentors to record any accepted or rejected mentoring relationships for future references.

At block 405, it is to be determined whether the system should interpret the application rejection as a future ban from application or not. The system may ban any future application from the mentor to the mentee on this tutorial web document. Alternatively, the system may allow the mentor to apply to tutor this mentee at some future time on this tutorial web document or on another tutorial web document. For some embodiments, the system may ban the mentor from applying to tutor this mentee in all circumstances as requested by the mentee.

At block 406, the system may record the rejected application as a ban from future application. For some embodiments, the prospective mentor is notified of this ban in order to avoid expectations of future application. At block 407, the prospective mentor is denied mentorship and the mentoring process may end here.

At block 408, the rejected mentor is able to apply to this end user for this tutorial document again. For some embodiments, the mentor may be notified that the mentoring application was denied, and that the mentor is able to apply at some time in the future. In this situation, the rejected mentor may return to the mentor discovery phase, as illustrated in block 409 and described in more details in FIG. 3.

### Mentoring Finalization Process

FIG. 5 illustrates an example of a process where the mentor application is completed and the end user and mentor interact in a mentoring session. The process may start at block 500. At block 501, the system records the mentoring relationship between the accepted prospective mentor and the mentee. At block 502, it is to be determined whether the system should notify the prospective mentor of the accepted mentoring relationship. For some embodiments, the notification may be in the form of an email sent to the mentor. A notification may also be sent to the mentee. For some embodiments, the notification may be in the form a pop-up window when the mentor is signed on to the system. This is illustrated in block 503.

When there is no notification, the process may continue to block 504 where it is to be determined whether the system should display the mentoring session when either the accepted mentor or the mentee browses to the tutorial web document. When the mentoring session is to be opened automatically, the process may flow to block 505 where the mentoring session is opened. The process then flows from block 505 to block 507.

From block 504, when the mentoring session is not automatically opened, the process may flow to block 506. Here, either the mentor or the mentee may be required to actively acknowledge that they would like to view the mentoring session. An active acknowledgement may include, for example, selecting or clicking a button or a link to proceed to the mentoring session.

At block 507, the mentor and the mentee may interact with one another through the mentoring session and exchange information and assistance. The process may end at block 508. The process illustrated in FIG. 5 may enable the mentor and the mentee to successfully form a mentoring relationship which they can build on through the use of the mentoring session. For some embodiments, other mentors may also join this mentoring session. Alternatively, after the mentee becomes knowledgeable on this particular tutorial web document, the mentee may conversely turn around and decide to mentor others.

### Tutorial Web Document Interface

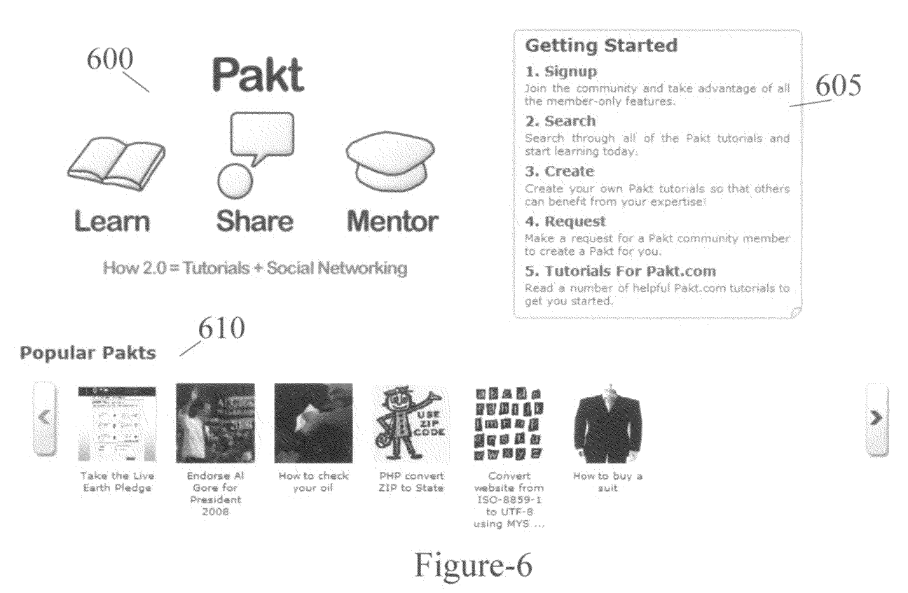

FIG. 6 illustrates an example of a portion of a web page that includes an interface providing tutorial web documents that may be used by an end user, in accordance with some embodiments. In the following examples, the web site PAKT is used to illustrate various web pages associated with tutorial web documents. Web page 600 may be used as an initial web page (or home page) that is displayed after the end user selects a universal resource locator (URL) or link associated with the web site. The web page 600 may include a getting started area 605 which provides options associated with the tutorial web documents. For example, the end user may use the getting started area 605 to search, to create, or to request for tutorial web documents. The web page may also include a popular area 610 that displays the popular tutorial web documents.

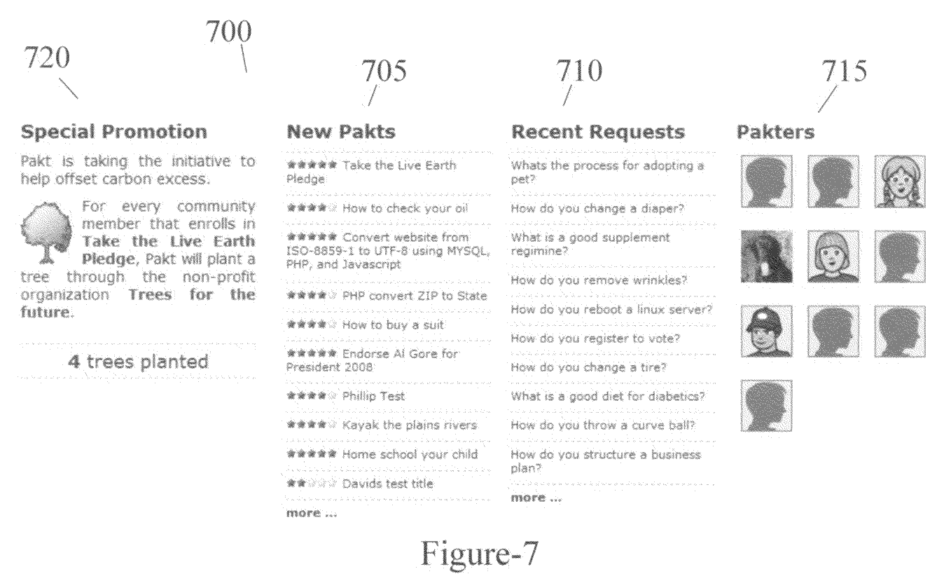

FIG. 7 illustrates an example of a portion of a web page that may be used to display other relevant information about the tutorial web documents, in accordance with some embodiments. Web page 700 may include a new tutorial web documents area 705, and recent requests for tutorial web documents area 710. Image area 715 may include multiple images that may be used by the end user to associate with the end user's profile. Special promotion area 720 may be used to display information that may be of interest to the end user.

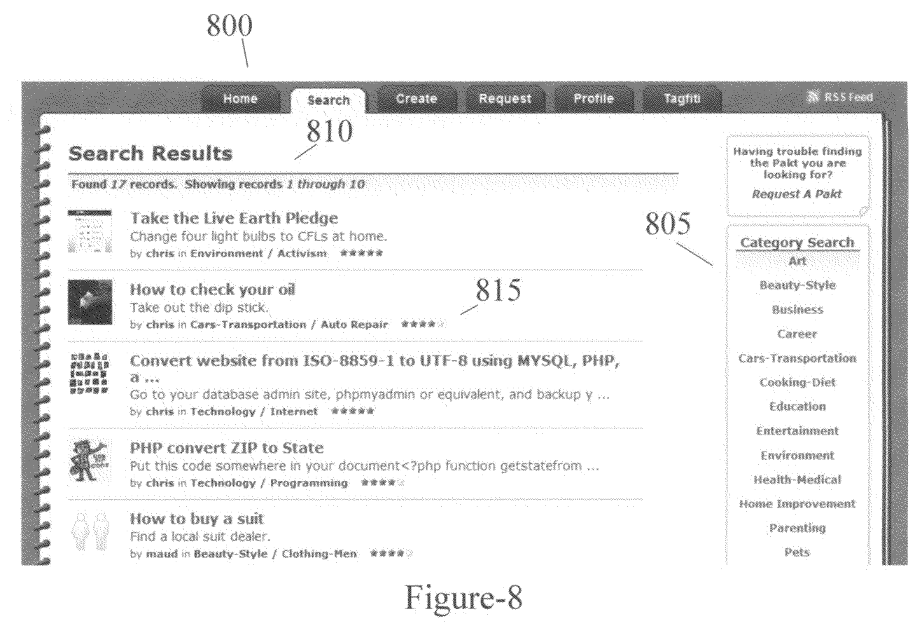

FIG. 8 illustrates an example of web page that may be used to display search results when searching for available tutorial web documents, in accordance with some embodiments. Web page 800 may include a category area 805 which lists multiple categories that the end user may use to search. The tutorial web documents that are available to be browsed may have been previously categorized. For example, the categorization may have been performed when the tutorial web document is created. The results of a search may be displayed in the search results area 810. With each tutorial web document in the search results area 810, there may be a description, information associated with the creator, rating information by other end users who have browsed the particular tutorial web document.

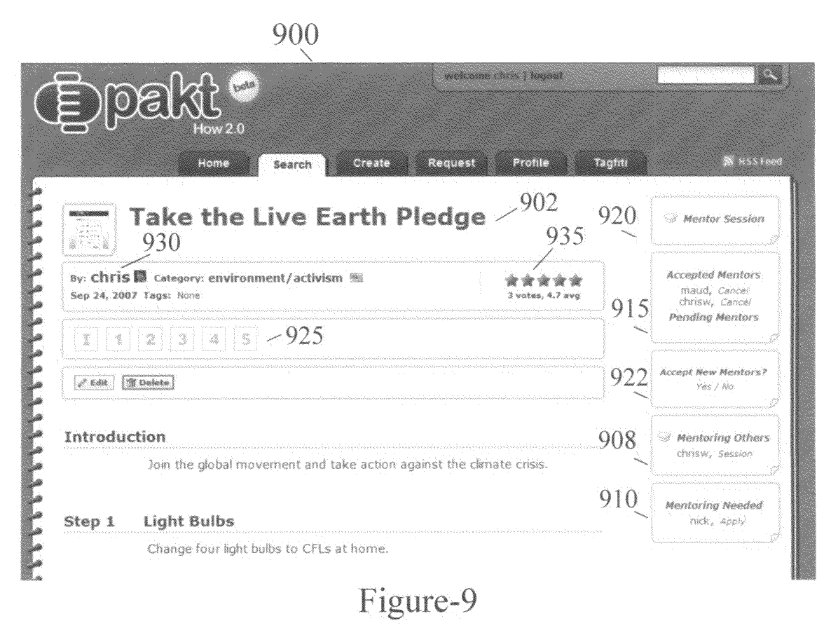

FIG. 9 illustrates an example of a web page that may be used to display detailed information about a tutorial web document, in accordance with some embodiments. Web page 900 may include the title of the tutorial web document 902, its creator 930, its number of sections or steps 925, and its ranking 935. As the end user completes each section or step of the tutorial web document, the end user may indicate set a completion indicator. For example, the end user may click on a check box to indicate completion of a step of the tutorial web document. When the end user selects progress tracking, the progress information may also be displayed and updated as the end user completes each section or step.

The web page 900 also includes “mentor session” area 920, “accept new mentors” area 922, “accepted and pending mentors” area 915, and “mentoring needed” area 910. When the end user is knowledgeable about the subject covered by the tutorial web document, the end user may apply to become a mentor. To apply, the end user may select the “apply” option associated with a requester mentee in the “mentoring needed” area 910. When the end user is not knowledgeable and wants to have a mentor, the end user may select a prospective mentor displayed in the “accepted and pending mentors” area 915. A selected prospective mentor may then become an accepted mentor, and the mentor's nick name (or user identification information) may be displayed underneath the “accepted mentors” heading of the “accepted and pending mentors” area 915. When the end user is mentoring another mentee, the mentee's nick name may be displayed in the “mentoring others” area 908. As may be noted, there may be two different mentoring sessions, one where the end user is a mentor, and another where the end user is a mentee.

An accepted mentor may be cancelled using the “cancel” option displayed in the “accepted and pending mentors” area 915. It may be noted that when there is no prospective mentor for a particular tutorial web document, the “accepted and pending mentors” area 915 may display no information under the “pending mentors” heading. When the end user does not need any mentor or is not accepting any mentors, the end user may so indicate by using the “accepting new mentors” area 922.

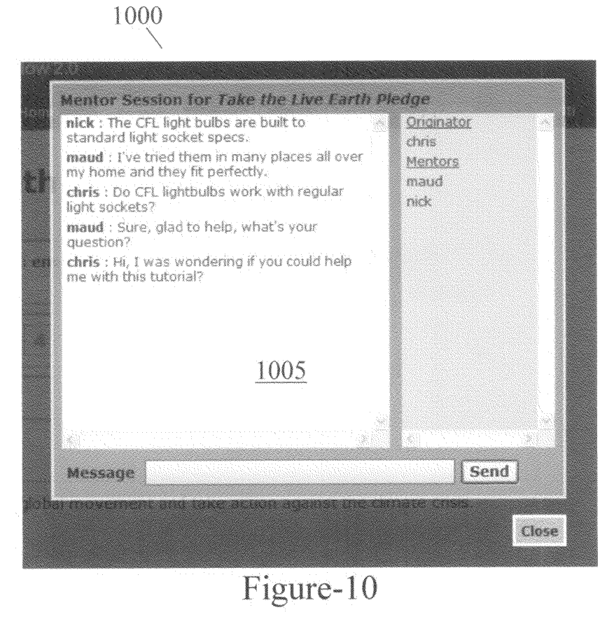

FIG. 10 illustrates an example of a web page that includes a mentoring session, in accordance with some embodiments. When the end user accepts a mentor, the end user may interact with the mentor via a mentoring session. For some embodiments, the mentoring session may be in the form of a private chat using the IRC protocol. Other forms of mentoring session may also be used. Web page 1000 illustrates an example of a chat session between a mentor and an end user via a chat window 1005.

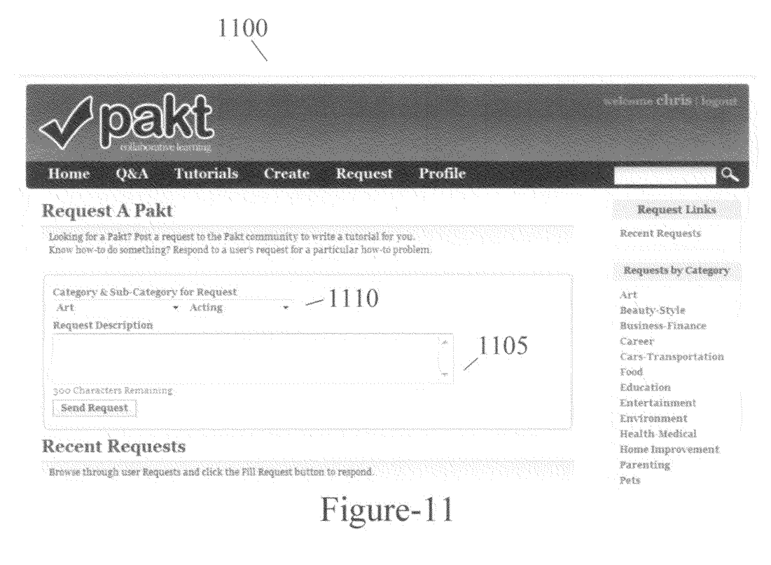

FIG. 11 illustrates an example of a web page that may be used to request a tutorial web document, in accordance with some embodiments. To request a tutorial web document, the end user may need to provide a description of the tutorial needed using the description input area 1105. The end user may also need to specify additional information using the category and subcategory input area 1110.

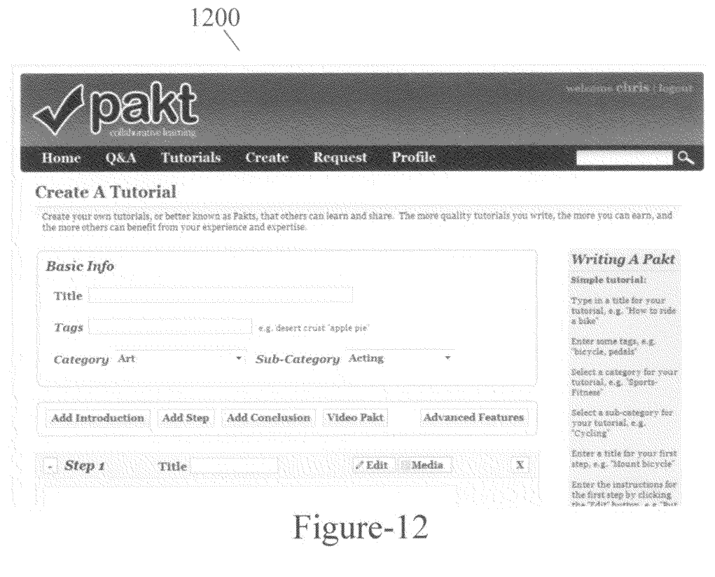

FIG. 12 illustrates an example of a web page that may be used to create a tutorial web document, in accordance with some embodiments. Web page 1200 may be used by an end user to author a tutorial web document. The web page 1200 may include a basic information input area 1205 to enable the end user to specify a title, a category and a subcategory associated with the tutorial web document. There may be a media input area 1210 to attach multimedia information to the tutorial web document. This may be performed by, for example, specifying a URL link and uploading an image or a video. The end user may create the tutorial web document one section or one step at a time. As more steps are needed, the user may use option to insert additional steps.

The example web pages illustrated in FIG. 6 to FIG. 12 may include options to enable an end user to accomplish one or more operations described in the processes illustrated in FIG. 1B to FIG. 5.

### Computer Readable Media

Embodiments of this invention (e.g., those described in FIGS. 1B-5) may be used as or to support software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

### CONCLUSION

Embodiments of the invention described herein may enable end users of tutorial web documents to track their progress of learning by sections, steps, or by the tutorial as a whole. The end users of the tutorial web documents may require mentorship to help them in their process of learning. The end users may mentor other end users to improve their process of learning. The mentors and mentees may interact in an ad-hoc private environment called a mentoring session.

Embodiments of methods and systems for tracking the progress and enabling private mentoring on tutorial web documents are described herein. In the above description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring the description.

The above description of illustrated embodiments of the invention, including what is described in the abstract, is not intended to be exhaustive or to be limitation to the precise forms disclosed. While specific embodiments of, and examples for, the invention are described herein for illustrative purposes, various equivalent modifications are possible, as those skilled in the relevant art will recognize.

These modifications can be made to embodiments of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation.

What is claimed is:

1. A method, comprising:
Displaying a tutorial web document organized by steps and/or sections;
Enabling a user or users to electronically track the learning progress of these steps and/or sections;

2. The method of claim 1, wherein the user or system starts to track progress.

3. The method of claim 1, wherein the progress is recorded electronically.

4. The method of claim 3, wherein the recorded progress information is displayed to the user, specific users, and/or the public.

5. The method of claim 3, wherein the recorded progress can be reset.

6. The method of claim 3, wherein the recorded progress can be edited or revised.

7. The method of claim 3, wherein the recorded progress information can be shared between specific users and/or across networks.

8. The method of claim 1, wherein users can track progress on multiple tutorials.

9. The method of claim 1, wherein specific users and/or groups of users can track progress on tutorial web documents.

10. The method of claim 1, wherein the user or system specifies when the progress has been completed.

11. The method of claim 10, further comprising:
When the progress has completed, the user is notified.

12. A method, comprising:
Displaying a tutorial web document; Enabling one or more users to privately exchange information related to the tutorial document;

13. The method of claim 12, wherein a user requests a private mentoring exchange with the public or specific users either anonymously or not.

14. The method of claim 13, wherein a user responds to a mentoring request.

15. The method of claim 14, wherein the originating user accepts the response for mentoring and a mentoring session is established.

16. The method of claims 15, wherein users who have a mentoring session established exchange information electronically.

17. The method of claim 16, wherein mentoring users can view the mentoring information exchanged between all users within the mentoring session.

18. The method of claim 16, wherein mentoring users can only view the mentoring information exchanged between themselves and the originating user.

19. The method of claim 16, wherein mentoring session information can be recorded by the system.

20. The method of claim 16, wherein mentoring session information can be exchanged across networks.

21. The method of claims 16, wherein the originating user can add or remove users from the mentoring session.

22. The method of claim 12, wherein a user can initiate one or multiple private mentoring sessions.

23. The method of claim 12, wherein a user can join one or multiple private mentoring sessions.
